(19) United States
(12) Patent Application Publication
(10) Pub. No.: US 2024/0310546 A1
(43) Pub. Date: Sep. 19, 2024

(54) THREE-DIMENSIONAL ULTRASONIC SEISMIC MODEL REAL-TIME IMAGING SYSTEM AND METHOD

(71) Applicants: CHINA UNIVERSITY OF PETROLEUM (EAST CHINA), QINGDAO (CN); INSTITUTE OF ACOUSTICS, CHINESE ACADEMY OF SCIENCES SCIENCES, BEIJING (CN)

(72) Inventors: Keyu LIU, QINGDAO (CN); Jianlei GAO, QINGDAO (CN); Jianliang LIU, QINGDAO (CN); Xueshen CAO, QINGDAO (CN); Xiao HE, QINGDAO (CN)

(21) Appl. No.: 18/671,986

(22) Filed: May 22, 2024

Related U.S. Application Data
(63) Continuation of application No. PCT/CN2022/134590, filed on Nov. 28, 2022.

(30) Foreign Application Priority Data
Dec. 1, 2021 (CN) 202111456015.5

(51) Int. Cl. G01V 1/34; G01V 1/28

(52) U.S. Cl. CPC G01V 1/345; G01V 1/282; G01V 2210/21; G01V 2210/512

(57) ABSTRACT

A real-time imaging system for a three-dimensional ultrasonic seismic model, which is used for three-dimensional real-time imaging of a seismic model in an indoor water tank experiment, comprising: an ultrasonic sensor network, comprising at least one emitting probe and at least one receiving probe spaced apart from each other to form a network, which is arranged above a seismic model; and a hardware subsystem, comprising a main control unit, an acquisition unit, an emitting unit, an industrial computer and a display, wherein the acquisition unit, the emitting unit and the industrial computer are electrically connected to the main control unit, the emitting probe is electrically connected to the emitting unit, the receiving probe is electrically connected to the acquisition unit, the display is electrically connected to the industrial computer, and a software subsystem is configured in the industrial computer.

The present application is a continuation application of the international application PCT/CN2022/134590, filed on Nov. 28, 2022, which claims priority to Chinese Patent Application No. 202111456015.5 filed to the CNIPA on Dec. 1, 2021 and entitled “THREE-DIMENSIONAL ULTRASONIC SEISMIC MODEL REAL-TIME IMAGING SYSTEM”, the disclosure of the above identified applications is hereby incorporated by reference in its entirety.

### TECHNICAL FIELD

The present application belongs to the technical field of geological simulation, and particularly relates to a real-time imaging system and an imaging method for a three-dimensional ultrasonic seismic model.

### BACKGROUND OF THE PRESENT INVENTION

In geological research, it is of great significance to study the sedimentary formation process of geological structures. There are various means to study the geological sedimentation process. One effective method is to simulate the erosion and deposition process of minerals such as sand and mud in a laboratory by using a water tank. During the simulation of geological sedimentation in the water tank, it is necessary to perform three-dimensional monitoring and imaging on an underwater geological model to obtain real-time data during the sedimentation process.

The ultrasonic imaging technology, as an effective way to obtain the three-dimensional structure of a target model, is widely applied in medical imaging, non-destructive testing, seismic model research and other fields. At present, there are two commonly used methods for three-dimensional ultrasonic imaging. The first method is to use two-dimensional array probes to emit scanning acoustic beams through phased array technology. This method has high requirements for indexes such as the directivity and consistency of the probe array, has a small scanning angle and a limited imaging region, and has high requirements for the target model. The second method is mechanical scanning imaging, which uses a single ultrasound probe to image each point, the ultrasonic probe is fixed on a positioning device, which moves the probe to scan and measure each point in the target area separately. However, this method has a slow measurement speed and a low signal-to-noise ratio of reflected waves under a complex interface, it cannot realize real-time imaging of a changing geological model.

### SUMMARY OF THE PRESENT INVENTION

In view of at least one deficiency in the related art, the present application provides a real-time imaging system and imaging method for a three-dimensional ultrasonic seismic model, so as to solve the technical problem that the existing ultrasonic imaging methods are highly limited or cannot realize real-time imaging.

In one aspect, the present application provides a real-time imaging system for a three-dimensional ultrasonic seismic model, which is used for three-dimensional real-time imaging of a seismic model in an indoor water tank experiment, comprising:

an ultrasonic sensor network, comprising at least one emitting probe and at least one receiving probe spaced apart from each other to form a network, which is arranged above a seismic model; and

a hardware subsystem, comprising a main control unit, an acquisition unit, an emitting unit, an industrial computer and a display, the acquisition unit, the emitting unit and the industrial computer being electrically connected to the main control unit, respectively, the emitting probe being electrically connected to the emitting unit, the receiving probe being electrically connected to the acquisition unit, the display being electrically connected to the industrial computer, and a software subsystem being configured in the industrial computer;

wherein, the main control unit controls, according to an instruction from the software subsystem, the emitting unit to excite the emitting probe to emit an acoustic beam; the acquisition unit synchronously acquires acoustic signals from all receiving probes and transmits wave train data to the main control unit; the main control unit uploads the wave train data to the industrial computer; and, the software subsystem post-processes the wave train data to obtain a three-dimensional imaging map of the seismic model.

In some embodiments, there is at least one acquisition unit, and each acquisition unit controls at least one receiving probe; each acquisition unit has at least one data processing module in an amount equal to the number of receiving probes it controls; and, an acoustic signal acquired by each receiving probe is amplified and filtered by a corresponding data processing module and then uploaded to the main control unit.

In some embodiments, each acquisition unit further comprises a multi-channel analog-to-digital converter (ADC) and a first field programmable gate array (FPGA) logic controller; and, the wave train data of all data processing modules in each acquisition unit are gathered and converted into digital signal in the multi-channel ADC, then uploaded to the first FPGA logic controller, and uploaded to the main control unit.

In some embodiments, each data processing module comprises a differential preamplifier, a band pass filter and a programmable gain amplifier which are electrically connected successively, wherein the differential preamplifier is electrically connected to one receiving probe, and the programmable gain amplifier is finally connected to the multi-channel ADC.

In some embodiments, the emitting unit comprises: a second FPGA logic controller, a high-voltage circuit, at least one H-bridge driving circuit and at least one impedance matching network, wherein the second FPGA logic controller is connected to the main control unit and is capable of receiving instructions from the main control unit; the number of H-bridge driving circuits is the same as the number of emitting probes, and all the H-bridge driving circuits are connected to the second FPGA logic controller; each H-bridge driving circuit is connected to the high-voltage circuit, and each H-bridge driving circuit is connected to a corresponding emitting probe through one impedance matching network.

In some embodiments, each H-bridge driving circuit is connected to the second FPGA logic controller through a driving chip, and each H-bridge driving circuit is controlled by the second FPGA logic controller through the driving chip and is provided with high voltage by the high-voltage circuit to generate an excitation waveform.

In some embodiments, an excitation mode of the emitting probe is at least one of a single pulse excitation signal, a Burst signal, a Blackman window function signal and a linear frequency modulation (LFM) signal.

In some embodiments, the main control unit comprises at least one first processor and a first memory connected to the first processor, a task management program is stored in the first memory; the task management program is executed by the first processor to implement the following process: scheduling processes of tasks of the main control unit according to preset priorities, and upgrading a priority of a task whose waiting time exceeds a threshold.

In some embodiments, a ratio of the number of emitting probes and the number of receiving probes is 1:4.

In some embodiments, the ultrasonic sensor network further comprises a positioning device, on which the emitting probe and the receiving probe are carried and which is used to move the emitting probe and the receiving probe to a detection region.

In some embodiments, the industrial computer comprises at least one second processor and a second memory connected to the second processor, and the software subsystem is stored in the second memory, functions of following program modules of the software subsystem are executed by the second processor:

a parameter control module, which is connected to the main control unit via an Gigabit Ethernet communication interface and configured to issues a parameter command to the main control unit;

a positioning control module, which is configured to control the positioning device to move the ultrasonic sensor network to the detection region;

a waveform display module, which is configured to display a waveform;

a data storage module, which is configured to store data;

a waveform data preprocessing module, which is configured to preprocess waveform data for subsequent imaging;

a time-frequency analysis module, which is configured to perform time-frequency analysis as required;

a two-dimensional interface imaging module, which is configured to perform two-dimensional interface imaging; and

a three-dimensional tomographic module, which is configured to perform three-dimensional tomographic imaging.

In some embodiments, after receiving the wave train data, the main control unit uploads the wave train data to the software subsystem; and, the software subsystem processes the wave train data by using a pre-stack migration imaging algorithm.

In some embodiments, the software subsystem performs pre-stack migration by a Kirchhoff integral method, wherein a recorded wave train is extrapolated downward from a receiving point according to a spatial range in which the recorded wave train may generate reflected waves, and performs wave field extrapolation and imaging using a Kirchhoff integral expression:

$$U ( x , y , z , t ) = \frac{- 1}{2 π} \int \int \frac{cos θ}{Rv} [ \frac{v}{R} u ( {x}_{0} , {y}_{0} , 0 , t + \frac{R}{v} ) + \frac{\partial u ( {x}_{0} , {y}_{0} , 0 , t + \frac{R}{v} )}{\partial t} ] dxdy \\ where : \\ cos θ = \frac{z}{R} \\ R = \sqrt{{( x - {x}_{0} )}^{2} + {( y - {y}_{0} )}^{2} + {z}^{2}}$$

where U(x, y, z) represents a displacement of an acoustic wave at a position (x, y, z); cos θ is an inclination factor, representing a change of amplitude with an exit angle; v is a sound velocity; and, R is a distance from a position (x, y, z) of an imaging point to a position (x₀, y₀, 0) of one receiving probe;

a travel time of an incident ray of the acoustic wave from an emitting point to the imaging point (x, y, z) is obtained by a ray tracing method, so as to obtain an imaging value of the emitting point; and, imaging values of all waveform gathers are superimposed according to the principle of superimposition of records of a same reflected point underground, so as to obtain a three-dimensional imaging map.

In some embodiments, the software subsystem divides imaging operation process into at least one operation part, and independently establishes a thread for each operation part to realize parallel operation.

In another aspect, the present application provides a real-time imaging method for a three-dimensional ultrasonic seismic model, which is used for three-dimensional real-time imaging of a seismic model in an indoor water tank experiment and uses the real-time imaging system according to described above, comprising the following steps:

an ultrasonic sensor network emitting and receiving acoustic signals: the ultrasonic sensor network comprises at least one emitting probe and at least one receiving probe spaced apart from each other to form a network, which is arranged above a seismic model; all receiving probes synchronously receiving acoustic signals after each emission, and when there is a plurality of emitting probes, the emit emitting probes emitting acoustic wave signals one by one; and

a hardware subsystem processing waveform data for imaging: the hardware subsystem comprises a main control unit, an acquisition unit, an emitting unit, an industrial computer and a display, and a software subsystem is configured in the industrial computer; the software subsystem in the industrial computer issuing an operation parameter to the main control unit; the main control unit controlling the emitting unit to excite the emitting probe; the acquisition unit synchronously acquiring receiving waveforms from all receiving probes and transmitting the receiving waveforms to the main control unit; the main control unit uploading data to the industrial computer, and the software subsystem performing data post-processing and finally displaying a three-dimensional imaging map of the model on the display.

In some embodiments, scheduling processes of tasks of the main control unit according to preset priorities, and upgrading a priority of a task whose waiting time exceeds a threshold.

In some embodiments, the acquisition unit is responsible for synchronous acquisition of waveform data from all receiving probes and transmitting waveform data to the main control unit; there is at least one acquisition unit, and each acquisition unit controls at least one receiving probe; each acquisition unit has at least one data processing module in an amount equal to the number of the receiving probes it controls; and, an acoustic signal acquired by each receiving probe is amplified and filtered by a corresponding data processing module and then uploaded to the main control unit.

In some embodiments, the emitting unit comprises a second FPGA logic controller, a high-voltage circuit, at least one driving chip, at least one H-bridge driving circuit and at least one impedance matching network; during operation, the main control unit issuing a parameter command to the second FPGA logic controller to set parameters; after the parameters are set, the second FPGA logic controller controlling each H-bridge driving circuit, which is provided with high voltage by the high-voltage circuit, through one driving chip to generate an excitation waveform, and the excitation waveform exciting a corresponding emitting probe after passing through one impedance matching network.

In some embodiments, after receiving wave train data, the main control unit uploading the wave train data to the software subsystem; and, the software subsystem processing the wave train data by using a pre-stack migration imaging algorithm.

In some embodiments, the software subsystem performing pre-stack migration by a Kirchhoff integral method, wherein a recorded wave train is extrapolated downward from a receiving point, according to a spatial range in which the recorded wave train may generate reflected waves, and performing wave field extrapolation and imaging using a Kirchhoff integral expression.

Compared with the prior art, the present invention has the following advantages and positive effects.

(1) In the real-time imaging system for a three-dimensional ultrasonic seismic model provided in at least one of the embodiments of the present application, the emitting probes and the receiving probes are spaced apart from each other to form a network, which is arranged above the seismic model, so that the detection range can be expanded to the greatest extent, panoramic three-dimensional imaging can be performed on a model in the detection region without moving the probes during the detection process, and it can also have good imaging capability for complex geological structures.

(2) In the real-time imaging system for a three-dimensional ultrasonic seismic model provided in at least one of the embodiments of the present application, by using the principle of the multiple coverage observation system and the pre-stack migration method in the three-dimensional seismic exploration, by using a network-type sensor arrangement and in combination with the multi-channel synchronous excitation acquisition system and the high-resolution imaging algorithm, it enables three-dimensional imaging of multi-layered complex geological models without moving the probes, so that the measurement time is greatly saved. Moreover, the invalid clutter and noise can be effectively suppressed, and a high-quality three-dimensional imaging map can be obtained, so that the sedimentation process of the geological model is monitored in real time.

(3) In the real-time imaging system for a three-dimensional ultrasonic seismic model provided in at least one of the embodiments of the present application, similar to marine seismic simulation detection, the dynamic image of the changing multi-layered complex geological model can be obtained after the sedimentation experiment by the rapid measurement and the real-time migration processing and imaging of data, so that the experimental efficiency and the imaging accuracy are greatly improved. This system has good real-time performance, imaging quality and detection range, and has a promising application prospect in the study of geological sedimentation, marine geology, three-dimensional seismic model and other aspects.

### DETAILED DESCRIPTION OF THE PRESENT INVENTION

The accompanying drawings to be described herein are used for providing further understanding of the present application and constitute a part of the present application. Illustrative embodiments of the present application and descriptions thereof are used for explaining the present application, rather than constituting inappropriate limitations to the present application. In the accompanying drawings:

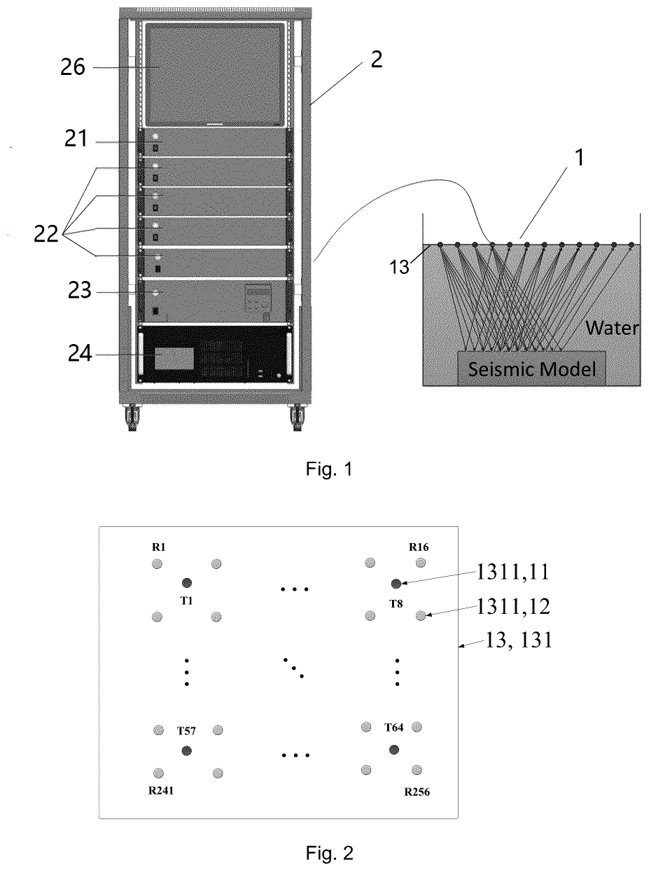

FIG. 1 is a schematic diagram of an overall structure according to an embodiment of the present application;

FIG. 2 is a distribution diagram of an ultrasonic sensor network according to an embodiment of the present disclosure;

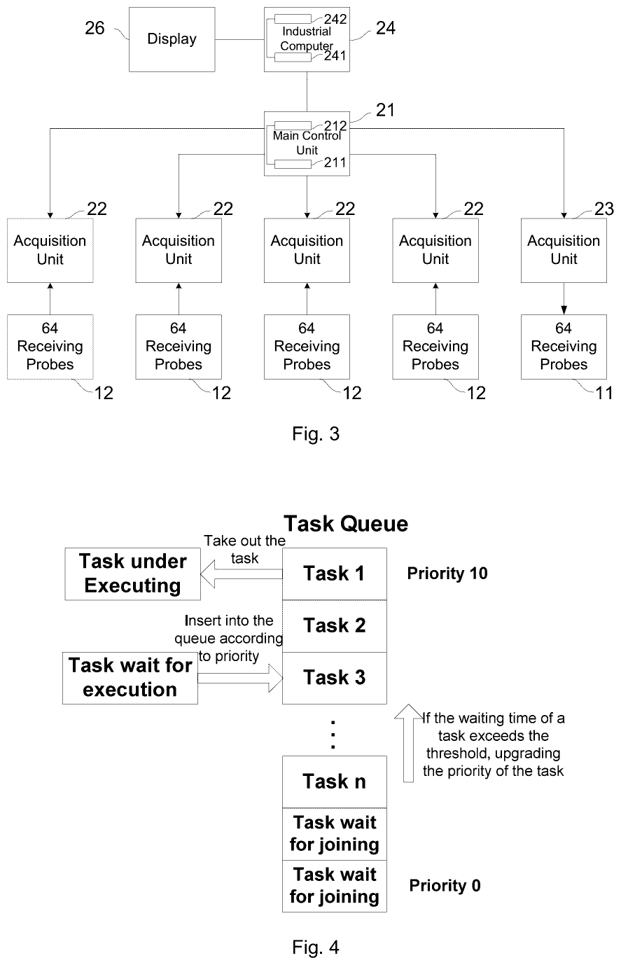

FIG. 3 is a control diagram of a main control unit according to an embodiment of the present application;

FIG. 4 is a flowchart of a task management procedure according to an embodiment of the present application;

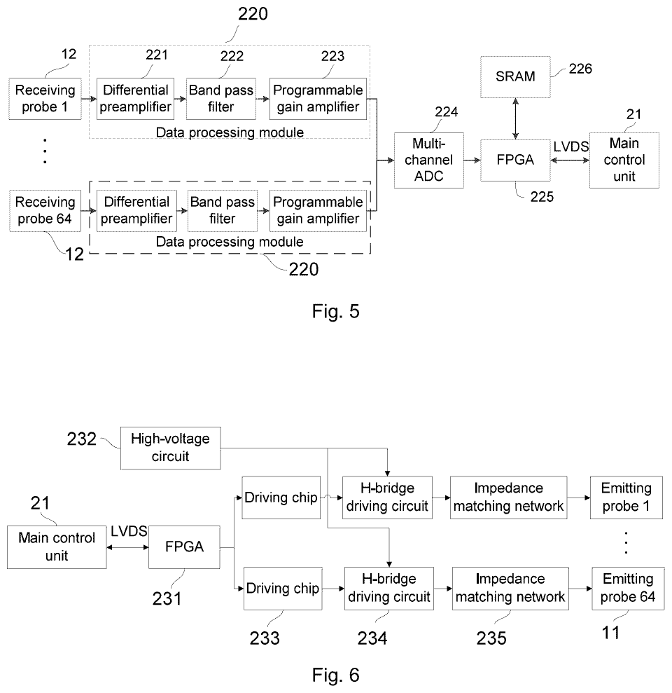

FIG. 5 is a frame structure diagram of an acquisition unit according to an embodiment of the present application;

FIG. 6 is a frame structure diagram of an emitting unit according to an embodiment of the present application;

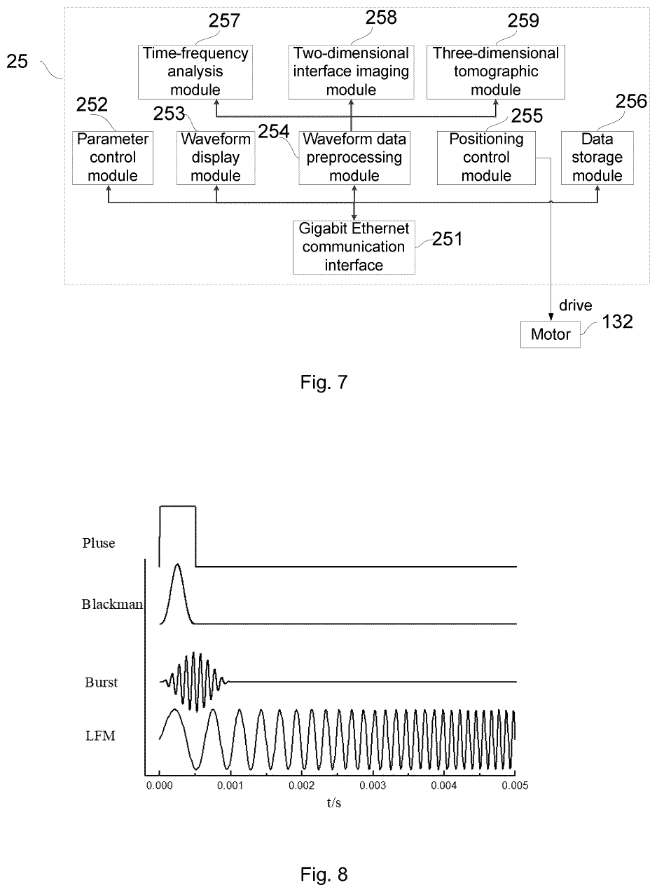

FIG. 7 is a frame structure diagram of a software subsystem according to an embodiment of the present application;

FIG. 8 is a schematic diagram of excitation signals in multiple emitting modes according to an embodiment of the present application;

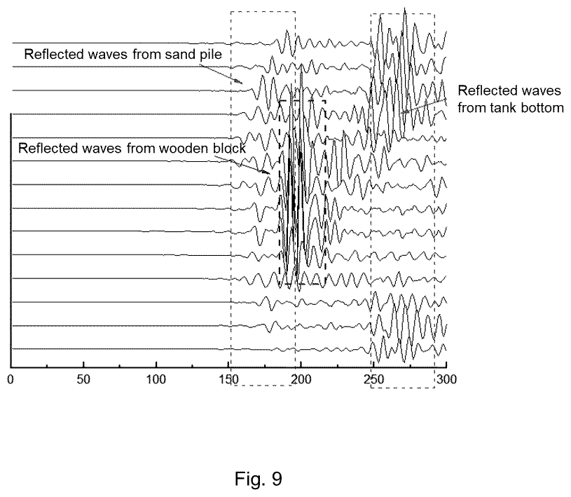

FIG. 9 is a schematic diagram of wave train after imaging according to an embodiment of the present application;

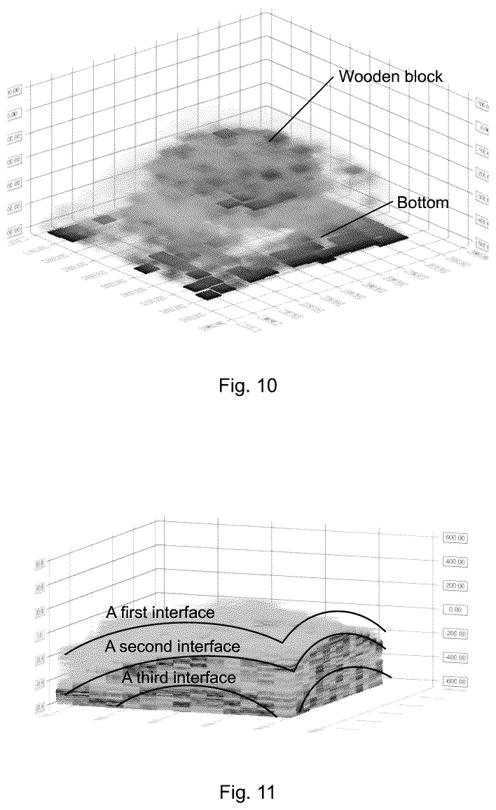

FIG. 10 is a three-dimensional imaging map of a sand model according to an embodiment of the present application; and

FIG. 11 is a three-dimensional imaging map of a three-layer geological model according to an embodiment of the present application;

in which:

1: ultrasonic sensor network; 11: emitting probe; 12: receiving probe; 13: positioning device; 131: support plate; 1311: mounting hole; 132: motor;

2: hardware subsystem; 21: main control unit; 211: first processor; 212: first memory; 22: acquisition unit; 23: emitting unit; 24: industrial computer; 241: second processor; 242: second memory; 25: software subsystem; 26: display;

221: differential preamplifier; 222: band pass filter; 223: programmable gain amplifier; 224: multi-channel ADC; 225: first FPGA logic controller; 226: SRAM;

231: second FPGA logic controller; 232: high-voltage circuit; 223: driving chip; 234: H-bridge driving circuit; 235: impedance matching network;

251: Gigabit Ethernet communication interface; 252: parameter control module; 253: waveform display module; 254: waveform data preprocessing module; 255: positioning control module; 256: data storage module; 257: time-frequency analysis module; 258: two-dimensional interface imaging module; and, 259: three-dimensional tomographic module.

### BRIEF DESCRIPTION OF THE DRAWINGS

The technical solutions in the embodiments will be described clearly and completely below with reference to the accompanying drawings. Apparently, embodiments to be described in the specific implementations are merely some but not all of the embodiments of the present application. Based on the embodiments of the present application, all other embodiments obtained by those of ordinary skill in the art without creative efforts shall fall within the protection scope of the present application.

Apparently, the accompanying drawings in the following description are merely some of the examples or embodiments of the present application. For a person of ordinary skill in the art, without paying any creative effort, the present application can also be applied to other similar circumstances according to these accompanying drawings. In addition, it should also be understood that, although the effort made in the development process may be complicated and tedious, for a person of ordinary skill in the art related to the disclosure of the present application, some modifications in design, manufacture or production based on the technical contents disclosed by the present application are merely conventional technical means, and it should not be understood that the disclosure of the present application is insufficient.

The term “embodiment” herein means that specific features, structures or characteristics described with reference to an embodiment can be included in at least one embodiment of the present application. The appearance of “embodiment” in various places of the description neither necessarily refers to the same embodiment, nor means an independent or alternative embodiment that is mutually exclusive with other embodiments. It should be explicitly and implicitly understood by those skilled in the art that an embodiment can be combined with other embodiments if not conflicted.

Unless otherwise defined, the technical terms or scientific terms involved in the present application should have their ordinary meanings as understood by a person of ordinary skill in the technical field to which the present application pertains. Similar words such as “a”, “an”, “one” and “the” involved in the present application do not mean any quantity limitation, and may mean a singular or plural form. The terms such as “include”, “comprise” and “have” and variants thereof involved in the present application are intended to cover non-exclusive inclusion. For example, a process, method, system, product or device including a series of steps or modules (units) is not limited to the listed steps or units, and may optionally include steps or units that are not listed or optionally include other steps or units intrinsic to this process, method, product or device. Similar words such as “connect”, “link” and “couple” involved in the present application are not limited to physical or mechanical connection, and may include electrical connection, regardless of direct or indirect connection. The term “a plurality of” involved in the present application means two or more. The terms “first” and “second” involved in the present application are merely for distinguishing similar objects, rather than indicating a specific order for the objects. The term “a plurality of” involved in the present application means two or more.

An embodiment of the present application provides a real-time imaging system for a three-dimensional ultrasonic seismic model, which can be used to perform three-dimensional monitoring and imaging on an underwater geological model in an indoor experiment process of simulating geological sedimentation in a water tank, so as to obtain real-time data during the sedimentation process.

With reference to FIGS. 1-3, the real-time imaging system for a three-dimensional ultrasonic seismic model in the embodiment of the present application comprises an ultrasonic sensor network 1 and a hardware subsystem 2.

Specifically, the ultrasonic sensor network 1 comprises at least one emitting probe 11 and at least one receiving probe 12 spaced apart from each other to form a network, which is arranged above a seismic model. Optionally, a ratio of the number of emitting probes 11 to the number of receiving probes 12 is 1:4. In a specific implementation, the ultrasonic sensor network 1 comprises 64 emitting probes 11 and 256 receiving probes 12, and the ultrasonic sensor network 1 is fixed on a bracket above the seismic model. As shown in FIG. 2, T1-T64 are emitting probes 11, R1-R256 are receiving probes 12, and the emitting probes 11 and the receiving probes 12 are spaced apart from each other to form a network. In this distribution mode, the detection range can be expanded to the greatest extent while using a certain number of probes, panoramic three-dimensional imaging can be performed on a model in the detection region, and it can also have good imaging capability for complex geological structures. During operation, 64 emitting probes 11 emit signals one by one, and all receiving probes 12 synchronously receive acoustic signals after each emitting probe 11 completes emission, and total 16384 pieces of waveform data are obtained after one operation. By imaging a large number of waveform data, the interference and noise can be minimized, so that a high-quality three-dimensional imaging map can be obtained.

In some embodiments, the ultrasonic sensor network 1 comprises a plurality of emitting probes 11 and a plurality of receiving probes 12; and there are multiple receiving probe 12 arranged around each emitting probe 11 at intervals. In some embodiments, when the number of the emitting probes 11 to the number of the receiving probes 12 is 1:4, every four receiving probes 12 form a square or rectangle (that is, the receiving probes 12 are located at four corners of the square or the rectangle), and one emitting probe 11 is arranged in the center of each square or rectangle. In the embodiment shown in FIG. 2, the ultrasonic sensor network 1 comprises 64 emitting probes 11 and 256 receiving probes 12; the 256 receiving probes 12 are arranged at equal intervals in 16 rows with 16 receiving probes 12 in each row; the 64 emitting probes 11 are arranged in 8 rows with 8 emitting probes 11 in each row; and, each emitting probe 11 is located in the center of the square formed by four receiving probes 12.

In some embodiments, the ultrasonic sensor network 1 further comprises a positioning device 13, on which the emitting probes 11 and the receiving probes 12 are carried and which is used to move the emitting probes 11 and the receiving probes 12 to a detection region. Optionally, the positioning device 13 comprises a support plate 131, mounting holes 1311 are formed on an upper surface of the support plate 131 according to the distribution of the emitting probes 11 and the receiving probes 12 in the ultrasonic sensor network 1 in FIG. 2, and the emitting probes 11 and the receiving probes 12 are sequentially mounted in the mounting holes 1311. The support plate 131 is connected to a motor 132, which can drive the positioning device 13 to move along a preset track.

The hardware subsystem 2 comprises a main control unit 21, an acquisition unit 22, an emitting unit 23, an industrial computer 24 and a display 26 which are mounted in a cabinet. The acquisition unit 22, the emitting unit 23 and the industrial computer 24 are electrically connected to the main control unit 21, respectively; the emitting probes 11 and the receiving probes 12 are electrically connected to the hardware subsystem 2 through shielded signal lines, respectively, and are further connected to the emitting unit 23 and the acquisition unit 22, respectively; the display 26 is electrically connected to the industrial computer 24; and, a software subsystem 25 is configured in the industrial computer 24.

In a specific implementation, during operation, the software subsystem 25 in the industrial computer 24 issues operation parameters such as sampling rate, sampling delay, wave train length and excitation waveform mode to the main control unit 21, so as to control the emitting unit 23 to excite the emitting probes 11 successively; the acquisition unit 22 synchronously acquires receiving waveforms from all the receiving probes 12, and transmits the receiving waveforms to the main control unit 21; the main control unit 21 uploads data to the industrial computer 24; and, the software subsystem performs data post-processing to finally obtain a three-dimensional imaging map of the model on the display 26.

As the core of the whole hardware subsystem 2, the main control unit 21 is mainly responsible for controlling the acquisition unit 22 and the emitting unit 23, issuing acquisition and emission parameters, receiving and uploading waveform data and the like. The main control unit 21 comprises at least one first processor 211, and the first processor 211 is used to execute the above control process of the main control unit 21.

Optionally, the main control unit 21 transmits data to the acquisition unit 22 and the emitting unit 23 via low voltage differential signaling (LVDS) high-speed data transmission buses. A LVDS bus itself is a serial data transmission structure, and in this system, a multi-line parallel transmission structure is adopted. There are 8 independent LVDS buses between the main control unit 21 and each subordinate unit (e.g., the acquisition unit 22 and the emitting unit 23), thus further accelerating the data transmission speed. Besides, the main control unit 21 communicates with the software subsystem 25 in the industrial computer 24 by using a Gigabit Ethernet, and the transmission speed can reach 113 MB/s, thus realizing the real-time transmission of data.

In some embodiments, a task management program is configured in the main control unit 21, the task management program schedules processes of tasks of the main control unit 21 according to preset priorities, and the task management program also upgrades a task whose waiting time exceeds a threshold. In a specific implementation, the main control unit 21 needs to control a plurality of subordinate units to operate in parallel, and also needs to perform data uploading, command reception, issuing and other operations. Conflicts between multiple tasks will result in data loss or even system crash. To prevent such occurrences, the task management program is configured in the main control unit 21 to simulate the task management mode of a computer system to realize internal task management, as shown in FIG. 4. The priority of each task is firstly set, and tasks are scheduled according to the order of the preset priorities. When scheduling occurs, it is firstly check whether a thread of a high-priority task is ready; and, if yes, the high-priority task is immediately delivered to an execution queue to wait for execution. Meanwhile, a task manager will record the waiting time of each task in the execution queue. If the waiting time of a task exceeds a threshold, the priority of the task will be upgraded, thus ensuring the stable operation of the system.

For example, in some embodiments, the main control unit 21 comprises at least one first processor 211 and a first memory 212 connected to the first processor 211; the first memory 212 stores the task management program; and, the task management program is executed by the first processor 211 to implement the following function: scheduling processes of tasks of the main control unit 21 according to preset priorities, and upgrading the priority of a task whose waiting time exceeds a threshold. Specifically, the priority of each task is firstly set, and tasks are scheduled according to the order of the preset priorities. When scheduling occurs, it is firstly check whether a thread of a high-priority task is ready; and, if yes, the high-priority task is immediately delivered to an execution queue to wait for execution. Meanwhile, a task manager will record the waiting time of each task in the execution queue. If the waiting time of a task is too long, the priority of the task will be upgraded, thus ensuring the stable operation of the system.

In some embodiments, there is at least one acquisition unit 22, and each acquisition unit 22 controls at least one receiving probe 12. For example, in some embodiments, as shown in FIG. 3, a distributed stricture is adopted, where one main control unit 21 controls 4 acquisition units 22 and 1 emitting unit 23, each acquisition unit 22 controls 64 receiving probes 12, and the emitting unit 23 controls 64 emitting probes 11. There are total 256 synchronous acquisition channels and 64 independent emission channels. The main control unit 21 communicates with the acquisition units 22 and the emitting unit 23 through independent interfaces, and the acquisition units 22 and the emitting unit 23 can operate independently without interference, so that the system can flexibly select the required subordinate units to operate in combination. Optionally, on the main control unit 21, there are 16 interfaces reserved for acquisition units 22 and 8 interfaces reserved for emitting units 23, allowing for an increase in the number of subordinate units according to requirements, thereby further expanding the detection range and improving the imaging accuracy.

In some embodiments, each acquisition unit 22 has at least one data processing module 220 in an amount equal to the number of the receiving probes 12 it controls, and the acoustic signal acquired by each receiving probe 12 is amplified and filtered by the corresponding data processing module 220 and then uploaded to the main control unit 21.

In some embodiments, each acquisition unit 22 further comprises a multi-channel analog-to-digital converter (ADC) 224 and a first field programmable gate array (FPGA) logic controller 225, and wave train data of all data processing modules 220 in each acquisition unit 22 is gathered and converted into digital signal in the multi-channel ADC 224, then uploaded to the first FPGA logic controller 225 and uploaded to the main control unit 21.

Further referring to FIG. 5, in some embodiments, each data processing module 220 comprises a differential preamplifier 221, a band pass filter 222 and a programmable gain amplifier 223 which are electrically connected successively, wherein the differential preamplifier 221 is electrically connected to one receiving probe 12, and the programmable gain amplifier 223 is finally connected to the multi-channel ADC 224.

In a specific implementation, the acquisition unit 22 is mainly responsible for the synchronous acquisition of waveform data from the receiving probes 12 and transmitting the waveform data to the main control unit 21, and each acquisition unit 22 controls 64 receiving probes 12. The acquisition units 22 comprises 64 data processing modules 220 corresponding to the receiving probes 12, respectively, a multi-channel ADC 224, a first FPGA logic controller 225 and other components, and each data processing module 220 comprises a differential preamplifier 221, a band pass filter 222 and a programmable gain amplifier 223, so that there are 64 independent acquisition channels corresponding to the 64 receiving probes 12. The acquisition unit 22 can independently control the sampling rate, the gain, the number of sampling points and other parameters of each acquisition channel. During operation, the wave train data acquired by each receiving probe 12 passes through the differential preamplifier 221, the band pass filter 22 and the programmable gain amplifier 223 in an independent acquisition channel, then converted into digital signal by the multi-channel ADC 224, uploaded to the first FPGA logic controller 225, and stored in the static random-access memory (SRAM) 226. Upon receiving an upload command from the main control unit 21, the first FPGA logic controller 225 uploads the data to the main control unit 21 via multi-line LVDS, thereby realizing the synchronous acquisition of the waveform data from 64 receiving probes 12. The acquisition unit 22 adopts a mode of synchronous parallel acquisition through 64 acquisition channels. This structure can satisfy the requirements for waveform synchronous acquisition of the ultrasonic sensor network 1 and also control the timing sequence and gain through the first FPGA logic controller 225, and can satisfy different requirements of the receiving probes 12 at different positions for waveform amplitude and delay time, so that the requirements of the system for wave train sampling from the 256 receiving probes 12 of the ultrasonic sensor network 1 are satisfied.

In some embodiments, the emitting unit 23 comprises a second FPGA logic controller 231, a high-voltage circuit 232, at least one H-bridge driving circuit 234 and at least one impedance matching network 235. The H-bridge driving circuit 234 is controlled by the second FPGA logic controller 231 according to instructions from the main control unit 21 and is provided with high voltage by the high-voltage circuit 232 to generate an excitation waveform, and the excitation waveform excites the corresponding emitting probes 11 to emit after passing through respective impedance matching network 235. In the present application, the high-voltage circuit 232 can provide a voltage of 10 V to 200 V.

In a specific implementation, specifically referring to FIG. 6, the emitting unit 23 is mainly responsible for the excitation of 64 emitting probes 11, and comprises a second FPGA logic controller 231, a high-voltage circuit 232, at least one H-bridge driving circuit 234 and at least one impedance matching network 235. During operation, the main control unit 21 issues a parameter command to the second FPGA logic controller 231 via an LVDS bus to set the emission waveform mode, the emission waveform pulse width, the excitation timing sequence of the emitting probes 11, and other parameters. After the parameters are set, each of the H-bridge driving circuits 234 is controlled by the second FPGA logic controller 231 through a driving chip 233 and is provided with high voltage by the high-voltage circuit 232 to generate an excitation waveform, and the excitation waveform excites a corresponding emitting probe 11 after passing through one the impedance matching network 235. The emitting unit 23 adopts a multi-channel independent excitation mode, and is divided into 64 independent excitation channels, which are controlled by the FPGA. This structure can realize independent emission control of any emitting probe 11, so that the requirements of the system for the emission order, emission waveform and combination of the emitting probes 11 are satisfied.

In some embodiments, as shown in FIG. 6, the emitting unit 23 comprises: a second FPGA logic controller 231, a high-voltage circuit 232, at least one H-bridge driving circuit 234 and at least one impedance matching network 235, wherein the second FPGA logic controller 231 is connected to the main control unit 21 and is capable of receiving instructions from the main control unit 21; the number of H-bridge driving circuits 234 is the same as the number of emitting probes, and all the H-bridge driving circuits 234 are connected to the second FPGA logic controller 231; and, each H-bridge driving circuit 234 is connected to the high-voltage circuit 232, and each H-bridge driving circuit 234 is connected to a corresponding emitting probe through one impedance matching network 235. The second FPGA logic controller 231 controls the H-bridge driving circuit 234 according to instructions from the main control unit 21, and the H-bridge driving circuit 234 is provided with high voltage by the high-voltage circuit 232 to generate an excitation waveform, and the excitation waveform excites the corresponding emitting probe 11 to emit after passing through respective impedance matching network 235.

In some embodiments, each H-bridge driving circuit 234 is connected to the second FPGA logic controller 231 through a driving chip 233, and each H-bridge driving circuit 234 is controlled by the second FPGA logic controller 231 through the driving chip 233 and is provided with high voltage by the high-voltage circuit 232 to generate an excitation waveform.

Optionally, an excitation mode of the emitting probe 11 is at least one of a single pulse excitation signal, a Burst signal, a Blackman window function signal and a linear frequency modulation (LFM) signal.

In a specific embodiment, as shown in FIG. 8, the emitting unit 23 utilizes sinusoidal pulse width modulation (SPWM) to achieve arbitrary waveform excitation of the emitting probe 11. In terms of the excitation mode of the emitting probe 11, the emitting unit 23 provides a variety of excitation signals for selection, comprising a single-pulse excitation signal, a Burst signal, a Blackman window function signal and an LFM signal. The proper excitation signal can be selected according to the measurement requirements. In the routine measurement, the single-pulse excitation signal can satisfy the measurement requirements; in cases where there are many clutters or the received wave train has complicated components, the Blackman window function signal and Burst signal can be used to obtain purer wave train signal; and, in the case of high noise or low signal-to-noise ratio of the wave train data, the LFM excitation mode can be used in combination with a pulse compression (PC) algorithm, so that the signal-to-noise ratio can be greatly increased and the imaging quality can be improved. The pulse width, main frequency and signal duration of all excitation signals can be adjusted in a certain range to adapt to geological models of various physical properties, and a proper excitation signal is selected according to different measurement environments and models, thus achieving the best imaging effect.

After receiving the wave train data, the main control unit 21 uploads the wave train data to the software subsystem 25, and the software subsystem 25 processes the wave train data by using a pre-stack migration imaging algorithm. The software subsystem 25 serves as a human-machine interface, and integrates hardware control, data processing and imaging, and displaying. The main functional modules of the software subsystem 25 is as shown in FIG. 7, comprising a Gigabit Ethernet communication interface 251, a parameter control module 252, a waveform display module 253, a waveform data preprocessing module 254, a positioning control module 255, a data storage module 256, a time-frequency analysis module 257, a two-dimensional interface imaging module 258 and a three-dimensional tomographic module 259.

In some embodiments, during operation, the parameter control module 252 of the software subsystem 25 firstly issues a parameter command to the main control unit 21 via the Gigabit Ethernet communication interface 251 using Gigabit Ethernet. Optionally, the ultrasonic sensor network 1 further comprises a positioning device 13, and the positioning control module 255 in the software subsystem 25 controls the positioning device 13 to move the ultrasonic sensor network 1 to a detection region according to the instruction from the software subsystem 25. Then, after the main control unit 21 uploads the wave train data, the waveform display module 253 displays the waveform and the data storage module 256 stores data, and waveform data is preprocessed by the waveform data preprocessing module 254 to prepare for next imaging. Finally, the preprocessed waveform data is subjected to time-frequency analysis by the time-frequency analysis module 257 as required, then subjected to two-dimensional interface imaging by the two-dimensional interface imaging module 258, and subjected to three-dimensional tomographic imaging by the three-dimensional tomographic module 259. The software subsystem 25 enables flexible control of parameters of the hardware system such as emission frequency, sampling rate and gain. After receiving the data, post-processing is conducted using the pre-stack migration imaging algorithm, so that invalid clutter and noise can be greatly suppressed and a clear imaging map can be obtained.

In some embodiments, the industrial computer 24 comprises at least one second processor 241 and a second memory connected to the second processor 241, the software subsystem 25 is stored in the second memory 242, and the functions of the following program modules of the software subsystem 25 are executed by the second processor 241:

a parameter control module 252, which is connected to the main control unit 21 via an Gigabit Ethernet communication interface 251 and configured to issues a parameter command to the main control unit 21;

a positioning control module 255, which is configured to control the positioning device 13 to move the ultrasonic sensor network 1 to the detection region;

a waveform display module 253, which is configured to display a waveform;

a data storage module 256, which is configured to store data;

a waveform data preprocessing module 254, which is configured to preprocess waveform data for subsequent imaging;

a time-frequency analysis module 257, which is configured to perform time-frequency analysis as required;

a two-dimensional interface imaging module 258, which is configured to perform two-dimensional interface imaging; and

a three-dimensional tomographic module 259, which is configured to perform three-dimensional tomographic imaging.

The waveform data preprocessing module 254 preprocesses the waveform data, mainly comprising actions such as band pass filtering and noise removal. The functions of the above program modules can be implemented by the method in the prior art, and it will not be limited in the present application.

In some embodiments, the positioning device 13 comprises a support plate 131 and a motor 132, the support plate 131 is driven by the motor 132. The support plate 131 may be made of an acrylic plate. The positioning control module 255 in the software subsystem 25 is executed by the second processor 241 in the industrial computer 24 to control the motor 132 to move the positioning device 13 to the detection region.

The software subsystem 25 performs pre-stack migration by a Kirchhoff integral method, wherein the recorded wave train is extrapolated downward from a receiving point according to a spatial range in which this wave train may generate reflected waves, and performs wave field extrapolation and imaging using a Kirchhoff integral expression. In a specific implementation, the software performs pre-stack migration by the Kirchhoff integral method, wherein a recorded wave train is extrapolated downward from a receiving point according to a spatial range in which this wave train may generate reflected waves, and performs wave field extrapolation and imaging using a Kirchhoff integral expression:

$$U ( x , y , z , t ) = \frac{- 1}{2 π} \int \int \frac{cos θ}{Rv} [ \frac{v}{R} u ( {x}_{0} , {y}_{0} , 0 , t + \frac{R}{v} ) + \frac{\partial u ( {x}_{0} , {y}_{0} , 0 , t + \frac{R}{v} )}{\partial t} ] dxdy \\ where : \\ cos θ = \frac{z}{R} \\ R = \sqrt{{( x - {x}_{0} )}^{2} + {( y - {y}_{0} )}^{2} + {z}^{2}}$$

in the above expression, U(x, y, z) represents a displacement of an acoustic wave at coordinates (x, y, z); cos θ is an inclination factor, representing a change of amplitude with an exit angle; v is a sound velocity; and, R is a distance from a position (x, y, z) of an imaging point to a position (x₀, y₀, 0) of one receiving probe 12. A travel time of an incident ray of the acoustic wave from an emitting point to the imaging point (x, y, z) is obtained by a ray tracing method, so as to obtain an imaging value of the emitting point. The imaging values of all waveform gathers are superimposed according to the principle of superimposition of the records of the same reflected point underground, so as to obtain a three-dimensional imaging map.

Specifically, the two-dimensional interface imaging module 258 and the three-dimensional tomographic module 259 in the software subsystem perform imaging using the above method.

The software subsystem 25 divides imaging operation process into at least one operation part, and independently establishes a thread for each operation part to realize parallel operation. In the pre-stack migration method, a large number of operations need to be performed on the waveform data, so that it takes lot of time. However, if the conventional linear program operation method is used, the imaging speed is slow. In order to increase the imaging speed, the imaging operation process is divided into a plurality of parts in the software, and a thread is independently established for each part to realize parallel operation, so that the computing capability of the multi-core CPU of the industrial computer 24 is utilized to the greatest extent to achieve the real-time imaging effect.

In another aspect, an embodiment of the present application provides a real-time imaging method for a three-dimensional ultrasonic seismic model, comprising the following steps:

an ultrasonic sensor network 1 emits and receives acoustic signals: the ultrasonic sensor network 1 comprises at least one emitting probe 11 and at least one receiving probe 12 spaced apart from each other to form a network, which is arranged above a seismic model; all receiving probes synchronously receive acoustic signals after each emission, and when there is a plurality of emitting probes, the emit emitting probes emit acoustic wave signals one by one;

a hardware subsystem 2 processes waveform data for imaging: the hardware subsystem 2 comprises a main control unit 21, an acquisition unit 22, an emitting unit 23, an industrial computer 24 and a display 26, and a software subsystem 25 is configured in the industrial computer 24; the software subsystem 25 in the industrial computer 24 issues an operation parameter to the main control unit 21; the main control unit 21 controls the emitting unit 23 to excite the emitting probe 11; the acquisition unit 22 synchronously acquire receiving waveforms from all receiving probes 12 and transmits the receiving waveforms to the main control unit 21; the main control unit 21 uploads data to the industrial computer 24, and the software subsystem 25 performs data post-processing and finally displays a three-dimensional imaging map of the model on the display 26.

In some embodiments, processes of tasks of the main control unit 21 are scheduled according to preset priorities, and a priority of a task whose waiting time exceeds a threshold is upgraded.

Specifically, the priority of each task is firstly set, and tasks are scheduled according to the order of the preset priorities. When scheduling occurs, it is firstly check whether a thread of a high-priority task is ready; and, if yes, the high-priority task is immediately delivered to an execution queue to wait for execution. Meanwhile, a task manager will record the waiting time of each task in the execution queue. If the waiting time of a task exceeds a threshold, the priority of the task will be upgraded, thus ensuring the stable operation of the system

In a specific embodiment, the acquisition unit 22 is responsible for the synchronous acquisition of waveform data from all receiving probes 12 and transmitting waveform data to the main control unit 21 to the main control unit 21. There is at least one acquisition unit 22, and each acquisition unit 22 controls at least one receiving probe 12. Each acquisition unit 22 has at least one data processing module 220 in an amount equal to the number of the receiving probes 12 it controls. The acoustic signal acquired by each receiving probe 12 is processed by the corresponding data processing module 220 and then uploaded to the main control unit 21.

In some embodiments, each acquisition unit 22 further comprises a multi-channel analog-to-digital converter (ADC) 224 and a first field programmable gate array (FPGA) logic controller 225, and wave train data of all data processing modules 220 in each acquisition unit 22 is gathered and converted into digital signal in the multi-channel ADC 224, then uploaded to the first FPGA logic controller 225 and uploaded to the main control unit 21. Specifically, after the main control unit 21 issues an uploading command to the first FPGA logic controller 225, the first FPGA logic controller 225 uploads data to the main control unit 21 via a multi-line LVDS bus, so as to realize the synchronous acquisition of waveform data from a plurality of receiving probes 12.

In some embodiments, the emitting unit 23 comprises a second FPGA logic controller 231, a high-voltage circuit 232, at least one driving chip 233, at least one H-bridge driving circuit 234 and at least one impedance matching network 235. During operation, the main control unit 21 issues a parameter command to the second FPGA logic controller 231 via an LVDS bus to set the emission waveform mode, the emission waveform pulse width, the excitation timing sequence of the emitting probes 11, and other parameters. After the parameters are set, each the H-bridge driving circuit 234 is controlled by the second FPGA logic controller 231 through one the driving chip 233 and is provided with high voltage by the high-voltage circuit 232 to generate an excitation waveform, and the high-voltage excitation waveform excites a corresponding emitting probe 11 after passing through one impedance matching network 235.

In some embodiments, after receiving the wave train data, the main control unit 21 uploads the wave train data to the software subsystem 25, and the software subsystem 25 processes the wave train data by using a pre-stack migration imaging algorithm.

In some embodiments, the software subsystem 25 performs pre-stack migration by a Kirchhoff integral method, wherein a recorded wave train is extrapolated downward from a receiving point according to a spatial range in which this wave train may generate reflected waves, and performs wave field extrapolation and imaging using a Kirchhoff integral expression.

In some embodiments, the software subsystem 25 divides imaging operation process into at least one operation part, and independently establishes a thread for each operation part to realize parallel operation.

### EMBODIMENT

The imaging effect of the three-dimensional real-time imaging system in an embodiment of the present application will be tested in an indoor water tank. Specifically, a model of tower-shaped sand pile is constructed in the water tank with a wooden block placed in the sand pile, and the water tank is filled with water. The ultrasonic sensor network 1 is arranged on the liquid level in the water tank. The sand pile model is imaged by the three-dimensional real-time imaging system in the embodiment of the present application. After collecting the raw waveform data, imaging process is performed by the software subsystem 25 to obtain the processed wave train, as shown in FIG. 9. It can be seen from FIG. 9 that the reflected waves from the inner wall of the water tank and the water surface are eliminated from the processed wave train. Thus, the reflected wave signals of the sand, the wooden block and the tank bottom can be clearly obtained.

The processed wave train is subjected to three-dimensional imaging to obtain a three-dimensional imaging map, as shown in FIG. 10. The surface profile of the sand model, the wooden block in the sand pile and the tank bottom can be clearly shown, thereby realizing three-dimensional imaging of the model.

Further, in order to verify the imaging effect of the system on a multilayer geological structure, a three-layer geological structure model is constructed in the water tank, including quartz sand (with a particle size of 20 to 40), pulverized coal and quartz sand (with a particle size of 80 to 120) from inside to outside. The three-layer geological structure model is measured by using the three-dimensional real-time imaging system in the embodiment of the present application to finally obtain a three-dimensional imaging map, as shown in FIG. 11. It can be seen from FIG. 11 that the imaging map can clearly show the interfaces of the three layers, thereby realizing three-dimensional tomographic imaging effects.

In a specific implementation, in the real-time imaging system and imaging method for a three-dimensional ultrasonic seismic model provided by the present application, the number of probes and the operating frequency of the sensor can be increased as required, so that the detection range and the imaging resolution are improved. Optionally, the hardware subsystem 2 of the present invention is small and portable, so that the real-time imaging system for a three-dimensional ultrasonic seismic model provided by the present application can be applied in other fields.

Finally, it is to be noted that, the embodiments are described progressively in this specification, with each embodiment focusing on the differences from the others, and the identical or similar parts among the embodiments can refer to each other.

The above embodiments are merely used for describing the technical solutions of the present application, rather than limiting the present application. Although the present application has been described in detail by preferred embodiments, it should be understood by a person of ordinary skill in the art that it is possible to make modifications to the specific implementations of the present application or equivalent replacements to some of the technical features without departing from the spirit of the technical solutions of the present application, and these modifications or equivalent replacements shall fall into the scope of the technical solutions sought to be protected by the present application.

1. A real-time imaging system for a three-dimensional ultrasonic seismic model, which is used for three-dimensional real-time imaging of a seismic model in an indoor water tank experiment, comprising:
an ultrasonic sensor network, comprising at least one emitting probe and at least one receiving probe spaced apart from each other to form a network, which is arranged above a seismic model; and
a hardware subsystem, comprising a main control unit, an acquisition unit, an emitting unit, an industrial computer and a display, the acquisition unit, the emitting unit and the industrial computer being electrically connected to the main control unit, respectively, the emitting probe being electrically connected to the emitting unit, the receiving probe being electrically connected to the acquisition unit, the display being electrically connected to the industrial computer, and a software subsystem being configured in the industrial computer;
wherein, the main control unit controls, according to an instruction from the software subsystem, the emitting unit to excite the emitting probe to emit an acoustic beam; the acquisition unit synchronously acquires acoustic signals from all receiving probes and transmits wave train data to the main control unit; the main control unit uploads the wave train data to the industrial computer; and, the software subsystem post-processes the wave train data to obtain a three-dimensional imaging map of the seismic model.

2. The real-time imaging system according to claim 1, wherein there is at least one acquisition unit, and each acquisition unit controls at least one receiving probe; each acquisition unit has at least one data processing module in an amount equal to the number of receiving probes it controls; and, an acoustic signal acquired by each receiving probe is amplified and filtered by a corresponding data processing module and then uploaded to the main control unit.

3. The real-time imaging system according to claim 2, wherein each acquisition unit further comprises a multi-channel analog-to-digital converter (ADC) and a first field programmable gate array (FPGA) logic controller; and, the wave train data of all data processing modules in each acquisition unit are gathered and converted into digital signal in the multi-channel ADC, then uploaded to the first FPGA logic controller, and uploaded to the main control unit.

4. The real-time imaging system according to claim 3, wherein each data processing module comprises a differential preamplifier, a band pass filter and a programmable gain amplifier which are electrically connected successively, wherein the differential preamplifier is electrically connected to one receiving probe, and the programmable gain amplifier is finally connected to the multi-channel ADC.

5. The real-time imaging system according to claim 1, wherein the emitting unit comprises: a second FPGA logic controller, a high-voltage circuit, at least one H-bridge driving circuit and at least one impedance matching network, wherein the second FPGA logic controller is connected to the main control unit and is capable of receiving instructions from the main control unit; the number of H-bridge driving circuits is the same as the number of emitting probes, and all the H-bridge driving circuits are connected to the second FPGA logic controller; each H-bridge driving circuit is connected to the high-voltage circuit, and each H-bridge driving circuit is connected to a corresponding emitting probe through one impedance matching network.

6. The real-time imaging system according to claim 5, wherein each H-bridge driving circuit is connected to the second FPGA logic controller through a driving chip, and each H-bridge driving circuit is controlled by the second FPGA logic controller through the driving chip and is provided with high voltage by the high-voltage circuit to generate an excitation waveform.

7. The real-time imaging system according to claim 5, wherein an excitation mode of the emitting probe is at least one of a single pulse excitation signal, a Burst signal, a Blackman window function signal and a linear frequency modulation (LFM) signal.

8. The real-time imaging system according to claim 1, wherein the main control unit comprises at least one first processor and a first memory connected to the first processor, a task management program is stored in the first memory; the task management program is executed by the first processor to implement the following process: scheduling processes of tasks of the main control unit according to preset priorities, and upgrading a priority of a task whose waiting time exceeds a threshold.

9. The real-time imaging system according to claim 1, wherein a ratio of the number of emitting probes and the number of receiving probes is 1:4.

10. The real-time imaging system according to claim 1, wherein the ultrasonic sensor network further comprises a positioning device, on which the emitting probe and the receiving probe are carried and which is used to move the emitting probe and the receiving probe to a detection region.

11. The real-time imaging system according to claim 10, wherein the industrial computer comprises at least one second processor and a second memory connected to the second processor, and the software subsystem is stored in the second memory, functions of following program modules of the software subsystem are executed by the second processor:
a parameter control module, which is connected to the main control unit via an Gigabit Ethernet communication interface and configured to issues a parameter command to the main control unit;
a positioning control module, which is configured to control the positioning device to move the ultrasonic sensor network to the detection region;
a waveform display module, which is configured to display a waveform;
a data storage module, which is configured to store data;
a waveform data preprocessing module, which is configured to preprocess waveform data for subsequent imaging;
a time-frequency analysis module, which is configured to perform time-frequency analysis as required;
a two-dimensional interface imaging module, which is configured to perform two-dimensional interface imaging; and
a three-dimensional tomographic module, which is configured to perform three-dimensional tomographic imaging.

12. The real-time imaging system according to claim 1, wherein after receiving the wave train data, the main control unit uploads the wave train data to the software subsystem; and, the software subsystem processes the wave train data by using a pre-stack migration imaging algorithm.

13. The real-time imaging system according to claim 12, wherein the software subsystem performs pre-stack migration by a Kirchhoff integral method, wherein a recorded wave train is extrapolated downward from a receiving point according to a spatial range in which the recorded wave train may generate reflected waves, and performs wave field extrapolation and imaging using a Kirchhoff integral expression:
$$U ( x , y , z , t ) = \frac{- 1}{2 π} \int \int \frac{cos θ}{Rv} [ \frac{v}{R} u ( {x}_{0} , {y}_{0} , 0 , t + \frac{R}{v} ) + \frac{\partial u ( {x}_{0} , {y}_{0} , 0 , t + \frac{R}{v} )}{\partial t} ] dxdy \\ where : \\ cos θ = \frac{z}{R} \\ R = \sqrt{{( x - {x}_{0} )}^{2} + {( y - {y}_{0} )}^{2} + {z}^{2}}$$
where U(x, y, z) represents a displacement of an acoustic wave at a position (x, y, z); cos θ is an inclination factor, representing a change of amplitude with an exit angle; v is a sound velocity; and, R is a distance from a position (x, y, z) of an imaging point to a position (x₀, y₀, 0) of one receiving probe;
a travel time of an incident ray of the acoustic wave from an emitting point to the imaging point (x, y, z) is obtained by a ray tracing method, so as to obtain an imaging value of the emitting point; and, imaging values of all waveform gathers are superimposed according to the principle of superimposition of records of a same reflected point underground, so as to obtain a three-dimensional imaging map.

14. The real-time imaging system according to claim 12, wherein the software subsystem divides imaging operation process into at least one operation part, and independently establishes a thread for each operation part to realize parallel operation.

15. A real-time imaging method for a three-dimensional ultrasonic seismic model, which is used for three-dimensional real-time imaging of a seismic model in an indoor water tank experiment and uses the real-time imaging system according to claim 1 to perform imaging, comprising the following steps:
an ultrasonic sensor network emitting and receiving acoustic signals: the ultrasonic sensor network comprises at least one emitting probe and at least one receiving probe spaced apart from each other to form a network, which is arranged above a seismic model; all receiving probes synchronously receiving acoustic signals after each emission, and when there is a plurality of emitting probes, the emit emitting probes emitting acoustic wave signals one by one; and
a hardware subsystem processing waveform data for imaging: the hardware subsystem comprises a main control unit, an acquisition unit, an emitting unit, an industrial computer and a display, and a software subsystem is configured in the industrial computer; the software subsystem in the industrial computer issuing an operation parameter to the main control unit; the main control unit controlling the emitting unit to excite the emitting probe; the acquisition unit synchronously acquiring receiving waveforms from all receiving probes and transmitting the receiving waveforms to the main control unit; the main control unit uploading data to the industrial computer, and the software subsystem performing data post-processing and finally displaying a three-dimensional imaging map of the model on the display.

16. The real-time imaging method according to claim 15, wherein scheduling processes of tasks of the main control unit according to preset priorities, and upgrading a priority of a task whose waiting time exceeds a threshold.

17. The real-time imaging method according to claim 15, wherein the acquisition unit is responsible for synchronous acquisition of waveform data from all receiving probes and transmitting waveform data to the main control unit; there is at least one acquisition unit, and each acquisition unit controls at least one receiving probe; each acquisition unit has at least one data processing module in an amount equal to the number of the receiving probes it controls; and, an acoustic signal acquired by each receiving probe is amplified and filtered by a corresponding data processing module and then uploaded to the main control unit.

18. The real-time imaging method according to claim 15, wherein the emitting unit comprises a second FPGA logic controller, a high-voltage circuit, at least one driving chip, at least one H-bridge driving circuit and at least one impedance matching network; during operation, the main control unit issuing a parameter command to the second FPGA logic controller to set parameters; after the parameters are set, the second FPGA logic controller controlling each H-bridge driving circuit, which is provided with high voltage by the high-voltage circuit, through one driving chip to generate an excitation waveform, and the excitation waveform exciting a corresponding emitting probe after passing through one impedance matching network.

19. The real-time imaging method according to claim 15, wherein after receiving wave train data, the main control unit uploading the wave train data to the software subsystem; and, the software subsystem processing the wave train data by using a pre-stack migration imaging algorithm.

20. The real-time imaging method according to claim 19, wherein the software subsystem performing pre-stack migration by a Kirchhoff integral method, wherein a recorded wave train is extrapolated downward from a receiving point, according to a spatial range in which the recorded wave train may generate reflected waves, and performing wave field extrapolation and imaging using a Kirchhoff integral expression.
